(19) United States
(12) Patent Application Publication
(10) Pub. No.: US 2016/0059653 A1
(43) Pub. Date: Mar. 3, 2016

(54) CAM ADJUSTABLE ASSEMBLY

(71) Applicant: GM GLOBAL TECHNOLOGY OPERATIONS LLC, Detroit, MI (US)

(72) Inventors: Hewen Gan, South Lyon, MI (US); John P. Powers, Oxford, MI (US)

(73) Assignee: GM GLOBAL TECHNOLOGY OPERATIONS LLC, Detroit, MI (US)

(21) Appl. No.: 14/601,313

(22) Filed: Jan. 21, 2015

Related U.S. Application Data
(60) Provisional application No. 62/043,479, filed on Aug. 29, 2014.

(51) Int. Cl. B60G 7/02; F16B 35/04

(52) U.S. Cl. CPC B60G 7/02; F16B 35/041

(57) ABSTRACT

A cam adjustable assembly generally includes a cam bolt, a cam washer, and a driving tool. The cam bolt includes a head and a shank coupled to the head. The shank includes a first shank portion coupled to the head. The second shank portion is coupled to the first shank portion. The cam washer can be coupled to the second shank portion. The cam washer includes a washer body and defines a shank receiving hole extending through the washer body and a tool receiving hole extends through the washer body. The shank receiving hole is configured to receive the second shank portion. The driving tool includes a tool body and a protrusion extending from the tool body. The protrusion is configured to be received in the tool receiving hole such that rotation of the driving tool causes the cam bolt to rotate.

### CROSS-REFERENCE TO RELATED APPLICATIONS

This application claims the benefit of U.S. Provisional Application No. 62/043,479, filed Aug. 29, 2014, which is hereby incorporated by reference in its entirety.

### TECHNICAL FIELD

The present disclosure relates to a cam adjustable assembly for adjusting the position of a control arm relative to a vehicle body.

### BACKGROUND

Vehicle suspension systems sometimes include a plurality of control arms. The control arm operatively couples a wheel to a vehicle body, while allowing relative movement between the vehicle body and the wheel. Specifically, the control arm serves as a link to establish proper wheel alignment in relation to the vehicle body.

### SUMMARY

It may be useful to move a control arm relative to the vehicle body in order to adjust the position or orientation of a wheel relative to the vehicle body. In order to adjust the position of the control arm, the vehicle may include a cam adjustable assembly as described in the present disclosure. The cam adjustable assembly includes a cam bolt having a head. The cam bolt can be turned in order to adjust the position of the control arm relative to the vehicle body. Although the cam bolt can be turned via the head, it is also useful to turn the cam bolt from another location that is more visible to the user than the head.

The present disclosure describes a system for adjusting the position of a control arm relative to the vehicle body. The system includes a cam adjustable assembly and a driving tool. The cam adjustable assembly allows a user to rotate a cam bolt from a location other than the head of the cam bolt. In an embodiment, the cam adjustable assembly generally includes a cam bolt, and a cam washer. The cam bolt includes a head and a shank coupled to the head. The shank includes a first shank portion coupled to the head and a second shank portion coupled to the first shank portion. The cam washer can be coupled to the second shank portion. The cam washer includes a washer body and defines a shank receiving hole extending through the washer body and a tool receiving hole extending through the washer body. The shank receiving hole is configured to receive the second shank portion. The driving tool includes a tool body and a protrusion extending from the tool body. The protrusion is configured to be received in the tool receiving hole such that rotation of the driving tool causes the cam bolt to rotate when the protrusion is disposed in the tool receiving hole and the second shank portion is disposed in the shank receiving hole. The present disclosure also relates to a vehicle including the cam adjustable assembly.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a vehicular frame structure, a control arm, and a cam adjustable assembly for moving the control arm relative to the vehicular frame structure;

FIG. 2 is a schematic front view of the vehicular frame structure, the control arm, and the cam adjustable assembly shown in FIG. 1;

FIG. 3 is a schematic fragmentary, perspective view of the vehicular frame structure, the control arm, and the cam adjustable assembly of FIG. 1;

FIG. 4 is a schematic fragmentary, perspective view of the vehicular frame structure, the control arm, the cam adjustable assembly, and a driving tool coupled to a cam washer of the cam adjustable assembly;

FIG. 5 is a schematic cross-sectional view of the vehicular frame structure, the control arm, a bushing coupled to the control arm, and the cam adjustable assembly shown in FIG. 1;

FIG. 6 is a schematic front view of the control arm, a bushing coupled to the control arm, and the vehicular frame structure shown in FIG. 1;

FIG. 7 is a schematic perspective view of the cam adjustable assembly including a cam bolt, a cam washer, and a driving tool;

FIG. 8 is a schematic perspective view of the cam bolt shown in FIG. 7;

FIG. 9 is a schematic perspective view of the cam washer shown in FIG. 7;

FIG. 10 is a schematic perspective view of the driving tool shown in FIG. 7;

FIG. 11 is a schematic perspective view of a driving tool in accordance with an alternative embodiment; and

FIG. 12 is a fragmentary, perspective view of the vehicular frame structure, the control arm, the cam adjustable assembly, and the driving tool shown in FIG. 11.

### DETAILED DESCRIPTION

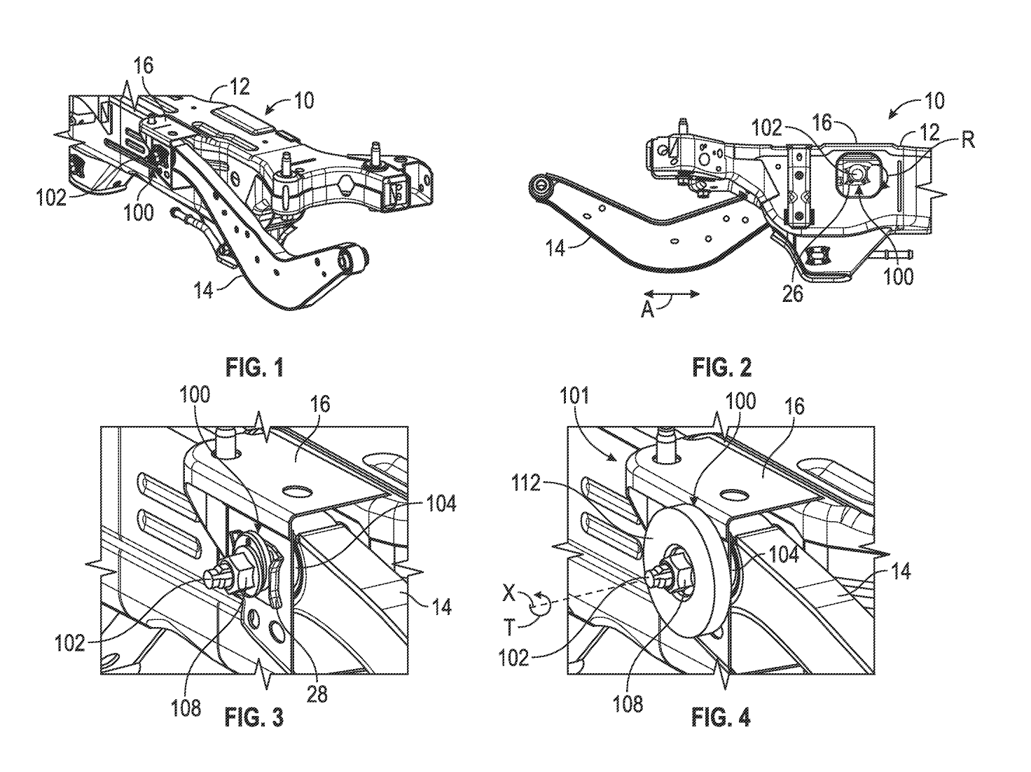

Referring to the drawings, wherein like reference numbers correspond to like or similar components throughout the several figures, and beginning with FIGS. 1-6, a vehicle 10 includes a vehicle body 12 and a control arm 14 movably coupled to the vehicle body 12. The vehicle 10 may be a car, a truck, or any other kind of vehicle. The vehicle body 12 includes a frame structure 16, such as a cradle, coupled to the control arm 14.

The control arm 14 is coupled to a wheel of the vehicle 10. During assembly of the vehicle 10, the control arm 14 can be moved relative to the frame structure 16 in order to adjust the position of the wheel relative to the vehicle body 12. It is useful to adjust the alignment of the wheel relative to the vehicle body 12 (and the frame structure 16) in order to adjust the camber and toe alignment of the wheel. The “camber alignment” refers to the orientation of the wheel, as measured along its vertical axis, relative to the vertical axis of the vehicle 10 when viewed from the front or rear. The “toe alignment” refers to the difference in the “across” distances between the front of the tires and the back of the tires. The camber and toe alignments can be adjusted by moving the control arm 14 relative to the frame structure 16.

The presently disclosed cam adjustable assembly 100 can be used to adjust the position of the control arm 14 relative to the vehicle body 12 in order to adjust the alignment of the wheel that is coupled to the control arm 14. Because the control arm 14 is coupled to the wheel, moving the control arm 14 relative to the vehicle body 12 causes the wheel to move relative to the vehicle body 12.

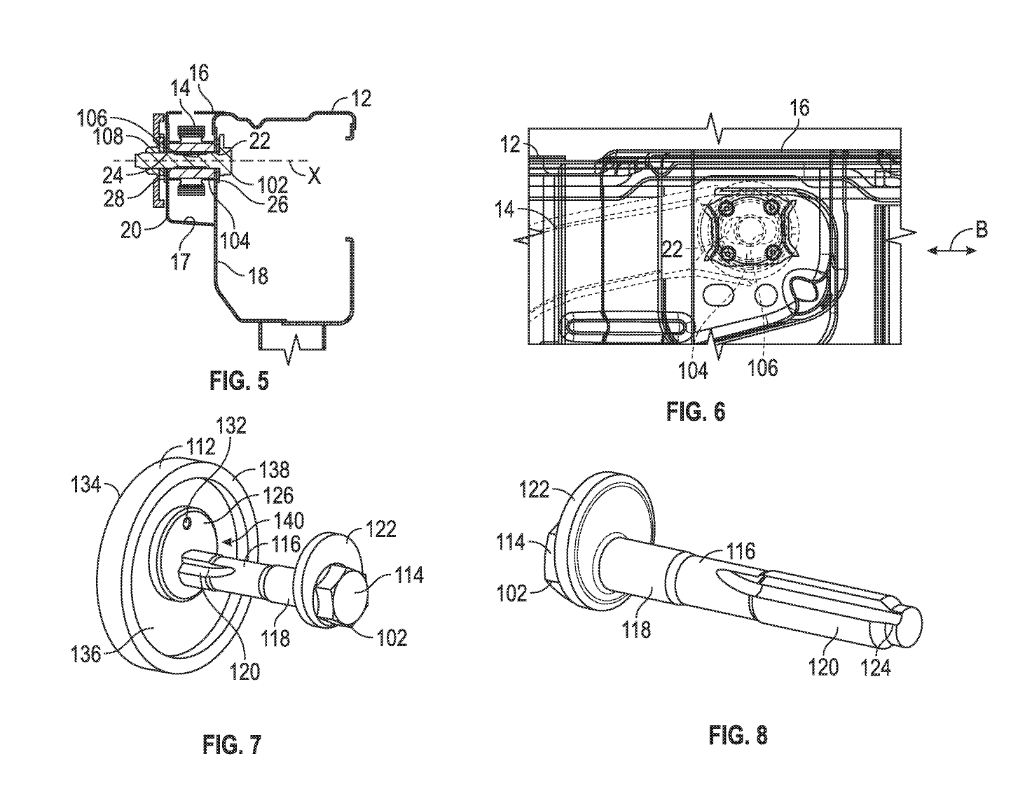

In the depicted embodiment, the cam adjustable assembly 100 includes a cam bolt 102 movably coupling the control arm 14 to the frame structure 16 via a bushing 104. The bushing 104 is disposed in an inner frame cavity 17 (FIG. 5) of the frame structure 16 and defines a bushing bore 106. The bushing bore 106 is configured, shaped, and sized to partly receive the cam bolt 102. The cam bolt 102 partly extends through the bushing 104 and can be rotated about the axis X (FIG. 5) in the direction indicated by arrow R (FIG. 2). It is envisioned that the cam bolt 102 can also be rotated in the direction opposite to the direction indicated by arrow R.

With reference to FIG. 5, the frame structure 16 includes a first frame wall 18 and a second frame wall 20 spaced apart from each other. The first frame wall 18 and the second frame wall 20 partially define the inner frame cavity 17. Accordingly, the inner frame cavity 17 is disposed between the first frame wall 18 and the second frame wall 20 and is configured, shaped, and sized to receive the bushing 104 and at least a portion of the control arm 14. The first frame wall 18 defines a first wall slot 22 (see also FIG. 6), and the second frame wall 20 defines a second wall slot 24. Each of the first wall slot 22 and the second wall slot 24 is configured, shaped, and sized to partly receive the cam bolt 102. The frame structure 16 additionally includes a first plate 26 coupled to the first frame wall 18 and a second plate 28 coupled to the second frame wall 20. The first plate 26 and the second plate 28 support the cam bolt 102 when the cam bolt 102 is coupled to the frame structure 16 and disposed through the first wall slot 22 and the second wall slot 24. The cam bolt 102 can be secured to the frame structure 16 using a nut 108. As discussed below, the cam bolt 102 can move along the first wall slot 22 and the second wall slot 24, and the nut 108 can be used to fix the position of the cam bolt 102 relative to the frame structure 16.

Because the cam bolt 102 is partially disposed in the first wall slot 22 and the second wall slot 24, rotating the cam bolt 102 also causes the cam bolt 102 to move along the first wall slot 22 and the second wall slot 24 in the direction indicated by double arrows B (FIG. 6). Because the cam bolt 102 is disposed in the bushing bore 106, moving the cam bolt 102 along the direction indicated by double arrows B causes the bushing 104, along with the control arm 14, to move axially in the directions indicated by double arrows A (FIG. 2). Accordingly, the position of the control arm 14 relative to the frame structure 16 can be adjusted by rotating the cam bolt 102. Once the control arm 14 is in the desired position relative to the frame structure 16, the nut 108 can be tightened to fix the position of the cam bolt 102 relative to the frame structure 16.

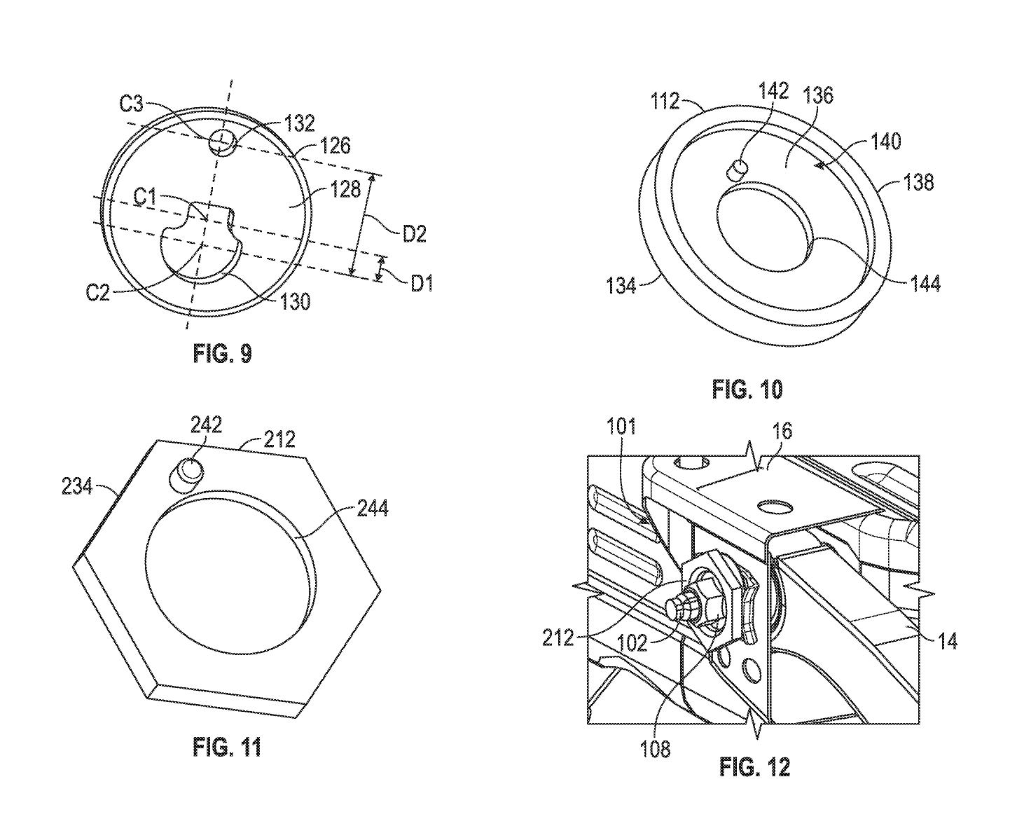

With reference to FIGS. 7-10, the cam adjustable assembly 100 includes a cam bolt 102, and a cam washer 126 coupled to the cam bolt 102. The cam adjustable assembly 101 is part of a system 101 that also includes a driving tool 112 configured to be coupled to the cam washer 126. The system 101 is configured to adjust the position of the control arm 14 relative to the frame structure 16. As shown in FIG. 7, the cam bolt 102 includes a head 114 configured to be driven by a tool, such as a wrench. To this end, the head 114 may have a hexagonal configuration that can be engaged by a wrench or any other suitable tool. The cam bolt 102 further includes a shank 116 coupled to the head 114. The shank 116 includes a first shank portion 118 coupled to the head 114 and a second shank portion 120 that is free (i.e., not coupled to any other portion of the shank 116 other than the first shank portion 118). The first shank portion 118 and the second shank portion 120 may have different cross-sectional shapes. In the depicted embodiment, the first shank portion 118 has a circumferential cross-section. Specifically, the first shank portion 118 has a circular cross-section. Regardless of its particular cross-sectional shape, the first shank portion 118 is configured, shaped, and sized to be received in the bushing bore 106. A head washer 122 is disposed around the first shank portion 118 and can be coupled to the first plate 26. In the depicted embodiment, the head washer 122 is integrally formed with the cam bolt 102 and is adjacent to the head 114. In particular, the cam bolt 102 and the head washer 122 are formed as a unitary or one-piece structure. However, it is contemplated that the head washer 122 may be a component separate from the cam bolt 102. Regardless, the head washer 122 can have a substantially planar and circular shape.

The shank 116 defines at least one longitudinal cut 124 along the second shank portion 120. For example, the shank 116 has two longitudinal cuts 124 disposed on opposite sides of the second shank portion 120 so as to define an irregular cross-sectional shape.

The cam adjustable assembly 100 additionally includes a cam washer 126 configured to be coupled to the second shank portion 120. The cam washer 126 can be coupled to the second plate 28 (see FIG. 3) and includes a washer body 128. The washer body 128 has a substantially disk-shape. In other words, the washer body 128 has a substantially circular and planar shape. Moreover, the cam washer 126 defines a shank receiving hole 130 extending through the washer body 128 and a tool receiving hole 132 extending through the washer body 128. The tool receiving hole 132 may have a circular shape. The shank receiving hole 130 is configured, shaped, and sized to receive the second shank portion 120 of the shank 116. Specifically, the cross-sectional shape of the shank receiving hole 130 matches the cross-sectional shape of the second shank portion 120 so that torque can be applied to the cam bolt 102 through the cam washer 126 as discussed in detail below.

The cam washer 126 defines a washer center C1, and the shank receiving hole 130 defines a first hole center C2. The first hole center C2 is offset from the washer center C1 by an offset distance D1 in order to allow the cam bolt 102 to move along the first wall slot 22 and the second wall slot 24 when it is rotated about the axis X (FIG. 5).

The cam adjustable assembly 100 further includes a driving tool 112 configured to be coupled to the cam washer 126. The driving tool 112 includes a tool body 134 having a tool base 136 and a circumferential lateral wall 138 protruding from the tool base 136. The driving tool 112 has a substantially circumferential perimeter, such as a circular perimeter, which is defined by the circumferential lateral wall 138. The tool base 136 and the circumferential lateral wall 138 collectively define a tool cavity 140 configured, shaped, and sized to receive the cam washer 126. The driving tool 112 further includes a protrusion 142, such as a pin, extending from the tool body 134. Specifically, the protrusion 142 extends from the tool base 136 and has a substantially cylindrical shape. Regardless of its shape, the cross-sectional shape of the protrusion 142 matches the cross-sectional shape of the tool receiving hole 132 to allow torque to be applied to the cam washer 126 via the driving tool 112. Thus, the tool receiving hole 132 is configured, shaped, and sized to receive the protrusion 142. The tool receiving hole 132 defines a second hole center C3 that is offset from the first hole center C2 by an offset distance D2 in order to allow the driving tool 112 to transfer sufficient torque to the cam washer 126 to rotate the cam bolt 102. When the protrusion 142 is disposed in the tool receiving hole 132 and the second shank portion 120 is disposed in the shank receiving hole 130, rotating the driving tool 112 causes the cam washer 126 to rotate, thereby causing the cam bolt 102 to rotate. The driving tool 112 also defines a nut receiving hole 144 extending through the tool body 134. Specifically, the nut receiving hole 144 extends through the center of the tool base 136 and is configured, shaped, and sized to receive the nut 108. The nut receiving hole 144 also functions as a second reaction point by the nut 108 for the torque applied through the driving tool 112 and the cam washer 126. The first reaction point is the tool receiving hole 132 on the cam washer 126. The greater the distance between these two reaction points, the lower the force applied is necessary for a given torque level.

During operation, the driving tool 112 can be used to rotate the cam bolt 102 when the head 114 is not as visible as the second shank portion 120 due to the vehicle packaging constraints. Thus, the driving tool 112 can be used to rotate the cam bolt 102 (from the second shank portion 120) in order to adjust the position of the control arm 14 relative to the frame structure 16. First, the cam washer 126 is coupled to the cam bolt 102. To do so, the second shank portion 120 is inserted through the shank receiving hole 130. Then, the driving tool 112 is coupled to the cam washer 126. To do so, the protrusion 142 is inserted through the tool receiving hole 132. Next, the driving tool 112 is rotated (manually or using a power tool) about the axis X in the direction indicated by arrow T (or the opposite direction) in order to rotate the cam washer 126. Because the driving tool 112 is coupled to the cam washer 126, rotating the driving tool 112 causes the cam washer 126 to rotate about the axis X. Because the cam washer 126 is coupled to the cam bolt 102, the rotation of the cam washer 126 causes the cam bolt 102 to rotate about the axis X. As the cam bolt 102 rotates, it also moves along the first wall slot 22 and the second wall slot 24 along the direction indicated by double arrows B (FIG. 6). As the cam bolt 102 moves axially, the bushing 104 (along with the control arm 14) moves relative to the frame structure 16 (and the vehicle body 12) in order to adjust the position of the wheel that is coupled to the control arm 14 relative to the vehicle body 12. The driving tool 112 is then decoupled from the cam washer 126.

With reference to FIGS. 11 and 12, another embodiment of the driving tool 212 has a tool body 234 and a protrusion 242 extending from the tool body 234. The driving tool 212 also defines a nut receiving hole 244 extending through the tool body 234. In this embodiment, the tool body 234 has a hexagonal perimeter to facilitate engagement with a suitable tool, such as a wrench.

While the best modes for carrying out the teachings have been described in detail, those familiar with the art to which this disclosure relates will recognize various alternative designs and embodiments for practicing the teachings within the scope of the appended claims.

1. A system, comprising:
a cam adjustable assembly including:
a cam bolt including a head and a shank coupled to the head, wherein the shank includes a first shank portion coupled to the head and a second shank portion coupled to the first shank portion;
a cam washer couplable to the second shank portion,
wherein the cam washer includes a washer body and defines a shank receiving hole extending through the washer body and a tool receiving hole extending through the washer body, and the shank receiving hole is configured to receive the second shank portion; and
a driving tool including a tool body and a protrusion extending from the tool body, wherein the protrusion is configured to be received in the tool receiving hole such that rotation of the driving tool causes the cam bolt to rotate when the protrusion is disposed in the tool receiving hole and the second shank portion is disposed in the shank receiving hole.

2. The system of claim 1, wherein the first shank portion and the second shank portion have different cross-sectional shapes.

3. The system of claim 1, wherein a cross-sectional shape of the second shank portion matches a cross-sectional shape of the shank receiving hole.

4. The system of claim 1, wherein a cross-sectional shape of the protrusion matches a cross-sectional shape of the tool receiving hole.

5. The system of claim 1, wherein the driving tool has a substantially circumferential perimeter.

6. The system of claim 1, wherein the driving tool has a hexagonal perimeter.

7. The system of claim 1, further comprising a nut coupled to the shank.

8. The system of claim 7, wherein the driving tool defines a nut receiving hole configured to receive the nut.

9. The system of claim 1, wherein the cam bolt includes a head washer disposed around the first shank portion and adjacent to the head.

10. The system of claim 1, wherein the driving tool defines a tool cavity configured to receive the cam washer.

11. A vehicle, comprising
a frame structure;
a control arm movably coupled to the frame structure;
a bushing coupled to the control arm;
a cam bolt coupling the bushing to the frame structure, wherein the cam bolt includes a head and a shank coupled to the head, and the shank includes a first shank portion coupled to the head and a second shank portion coupled to the first shank portion; and
a cam washer coupled to the second shank portion, wherein the cam washer includes a washer body and defines a shank receiving hole extending through the washer body and a tool receiving hole extending through the washer body, and the second shank portion extends through the shank receiving hole, and the cam washer is configured to engage a driving tool.

12. The vehicle of claim 11, wherein the first shank portion and the second shank portion have different cross-sectional shapes.

13. The vehicle of claim 11, wherein a cross-sectional shape of the second shank portion matches a cross-sectional shape of the shank receiving hole.

14. The vehicle of claim 11, wherein the driving tool includes a tool body and a protrusion extending from the tool body, wherein the protrusion extends through the tool receiving hole such that rotation of the driving tool causes the cam bolt to rotate in order to adjust a position of the control arm relative to the frame structure.

15. The vehicle of claim 14, wherein a cross-sectional shape of the protrusion matches a cross-sectional shape of the tool receiving hole.

16. The vehicle of claim 11, wherein the driving tool has a hexagonal perimeter.

17. The vehicle of claim 11, further comprising a nut coupled to the shank and configured to fix a position of the cam bolt relative to the frame structure.

18. The vehicle of claim 17, wherein the driving tool defines a nut receiving hole configured to receive the nut.

19. The vehicle of claim 11, wherein the cam bolt includes a head washer disposed around the first shank portion and adjacent to the head.

20. The vehicle of claim 11, wherein the frame structure defines a first wall slot and a second wall slot each configured to receive the shank.
